(19) United States
(12) Patent Application Publication
(10) Pub. No.: US 2011/0025045 A1
(43) Pub. Date: Feb. 3, 2011

(54) FITTING WITH AUDIBLE MISASSEMBLY INDICATOR

(75) Inventor: Erich Preimesberger, Bolingbrook, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 12/511,590

(22) Filed: Jul. 29, 2009

(51) Int. Cl. F16L 35/00

(52) U.S. Cl. 285/93

(57) ABSTRACT

A fitting (10) for communicating fluid from a source to a recipient includes a body (20) defining a thru-passage (28), the body having a first end portion (22) received by one of the source and the recipient (14, 18), and a second end portion (26) opposite the first end portion. An outlet (30) of the thru-passage (28) is defined by the second end portion (26). The fitting (10) also includes a misassembly indicator (40) is disposed between the first end portion (22) and the second end portion (26), wherein the misassembly indicator has an opening (42) in the body (20) in fluid communication with the thru-passage (28).

### BACKGROUND

Embodiments described herein generally relate to hose installation on engines. More specifically, embodiments described herein relate to fittings used to attach hoses on engines.

Assembly of engines requires that hoses be attached to the engine, for example at the intake manifold, to provide a generally sealed fluid transfer in and out of the engine. A fitting is received by the engine, for example at the intake manifold, and is configured to receive the hose. Clamps may be used to fixedly attach the hose onto the fitting. If the hose is not sealingly attached to the fitting in fluid communication with the engine, the engine and any apparatuses in fluid communication with the engine may not function properly.

In some instances, the integrity of the hose connection to the fitting may be checked with tools that automatically verify the integrity of the connection before the next assembly operation can be conducted. However, for many types of hose-to-fitting connections, hand tools are used to assemble the connection. Hand tools may not have the capability of providing an automatic integrity check to verify that the hose has a generally sealed fluid connection with the fitting.

### SUMMARY OF THE INVENTION

A fitting for communicating fluid from a source to a recipient includes a body defining a thru-passage, the body having a first end portion received by one of the source and the recipient, and a second end portion opposite the first end portion. An outlet of the thru-passage is defined by the second end portion. The fitting also includes a misassembly indicator is disposed between the first end portion and the second end portion, wherein the misassembly indicator has an opening in the body in fluid communication with the thru-passage.

### BRIEF DESCRIPTION OF THE DRAWINGS

FIG. 1 is a perspective view of an engine having a fitting with a misassembly indicator.

FIG. 2 is a perspective view of the engine having a second embodiment of a fitting with a misassembly indicator.

### DETAILED DESCRIPTION

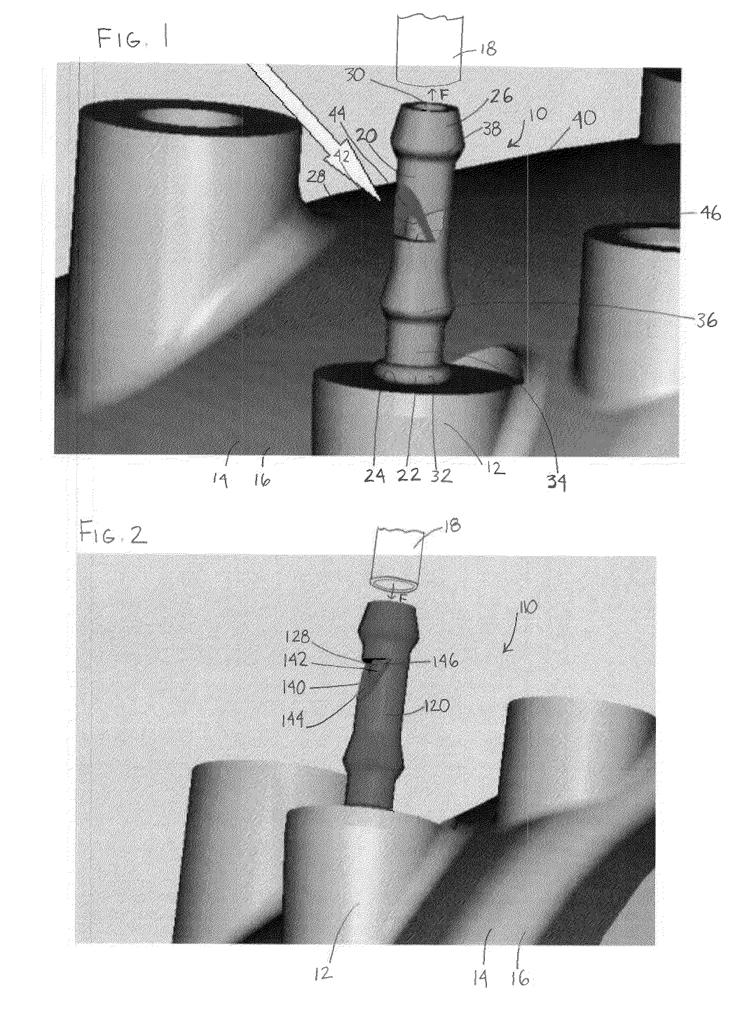

Referring now to FIG. 1, a first embodiment of a fitting is indicated generally at 10 and is disposed in a boss 12 of an engine 14, such as at an intake manifold 16. The boss 12 may provide a passage (not shown) for fluid communication from the intake manifold 16 of the engine 14 to the fitting 10. A hose 18 is received on the exterior surface of the fitting 10. While the fitting 10 is described below with respect to being disposed in the intake manifold 16 of an engine 14, it is possible that the fitting 10 may be used in any hose-to-fitting application of a fluid source and a fluid recipient.

The fitting 10 has a body 20, which may be generally tubular, having a first end portion 22 configured to be received in a receiving structure 24 of the boss 12, and a second end portion 26 opposite the first end portion. A thru-passage 28 is disposed generally centrally along an axis of the body 20. When the body 20 is received by the receiving structure 24, the thru-passage 28 is in fluid communication with the engine 14. An outlet 30 of the thru-passage 28 is located at the second end portion 26.

It is possible that the body 20 may have a shape other than tubular, for example a square cross-section. Any shape body 20 that encloses the thru-passage 28 is possible. The body 20 may be formed of metal or plastic, however other materials are possible. The body 20 may be integrally formed or non-integrally formed.

A stop 32 may be disposed on the fitting 10 and configured to engage the boss 12 to limit the amount of length of the fitting introduced into the receiving structure 22. The stop 32 may be an annular lip, although any other mechanical stop is possible.

A clamping portion 34 may be defined between the stop 32 and a barb 36. The clamping portion 34 may be an annular recess generally configured to receive a clamp (not shown). The barb 36 may retain the clamp in the clamping portion 34 between the barb 36 and the stop 32. The barb 36 may be an annular lip, however other shapes are possible. It is also possible that the clamping portion 34 may be defined in the body 20 without a stop 32 or a barb 36. The fitting 10 may have a top barb 38, or alternatively, the second end portion 26 may have a generally constant cross-sectional shape along the body 20.

The hose 18 is received at the second end portion 26 and on the exterior surface of the fitting 10. When the hose is received substantially along the length of the fitting 10, a clamp (not shown) may clamp the hose 18 to the fitting 10 at the clamping portion 34.

When the fitting 10 is received in the receiving structure 22 of the boss 12, the thru-passage 28 of the fitting is fluidly connected to the engine 14. When the hose 18 is attached to the fitting 10, the outlet 30 of the thru-passage 28 is fluidly connected to the hose 18. Thus when the hose 18 is connected to the fitting 10, a generally sealed fluid connection is provided between the engine 14, the fitting 10, and the hose 18. However, when the hose 18 is improperly assembled onto the fitting 10, there is no sealed fluid connection between the fitting and the hose to provide fluid from the engine 14 to the hose 18.

A misassembly indicator 40 is disposed on the fitting 10, and may be located between the first end portion 18 and the second end portion 26 of the fitting. The misassembly indicator 40 may include an opening 42 extending generally radially from the exterior surface to an interior surface of the body 20 providing a second outlet of the thru-passage 28. The misassembly indicator 40 may also include an incident surface 44, and an opposite surface 46 that define the opening 42. The incident surface 44 may be provided at a bias with respect to the axis of the thru-passage 28, however other orientations such as 90-degrees to the axis are possible. The incident surface 44 is configured to create an audible sound, such as a “whistle” sound when fluid flow out of the opening 42 is incident on the incident surface 44. The opposite surface 46 may be provided at any angle relative to the axis of the thru-passage 28. In this configuration, the misassembly indicator 40 is generally triangular in shape, however other shapes such as round or oval are possible.

In FIG. 1, the direction of fluid flow is indicated by the arrow F. The fluid from the engine 14 flows through the fitting 10 and is incident on the incident surface 44. If the hose 18 is properly connected over the fitting 10, and specifically, over the top of the opening 42 to seal the opening, then the fluid will continue to flow through the fitting to the second end portion 26, out the outlet 30 and to the hose 18.

If the hose 18 is not properly connected over the top of the fitting 10, and specifically over the top of the opening 42, at least a portion of the fluid flow will flow out of the opening, flow incident to the incident surface 44, and will make an audible “whistle” sound. Fluid flow through the opening 42 in the body 20 generates an audible sound.

The hose 18 may sufficiently block the fluid flow through the opening 42 in the body 20 when the hose is connected to the body extending up to the stop 32 to prevent the generation of an audible sound. The audible sound may be generated while the engine 14 is running when the hose 18 is not connected to the body 20 up to the stop 32 such that the hose does not block the flow of fluid through the opening 42 in the body.

With the fitting 10 having the misassembly indicator 40 is assembled onto the engine 14 and the hose 18 is assembled, either properly or improperly, a check of the hose-to-fitting assembly can be conducted by running the engine, for example at an end of line engine start test. If an audible “whistle” sound is detected, it is an indicator that fluid is escaping the fitting 10. The hose-to-fitting connections may be checked for improper assembly of the hose 18 to the fitting 10.

Referring now to FIG. 2, a second embodiment of fitting is indicated generally as 110 and is generally similar to the fitting 10 with exception of the orientation of the misassembly indicator 140. The fitting 110 is received in a receiving structure 24 of the engine where the direction of fluid flow is towards the engine 14 and indicated by the arrow F, for example for vacuum line applications.

The misassembly indicator 140 includes an opening 142 extending generally radially from the exterior surface to the interior surface of the body 120 providing a second outlet of the thru-passage 128. The misassembly indicator 140 may also include an incident surface 144, and an opposite surface 146 that define the opening 142. The incident surface 144 may be provided at an obtuse angle with respect to the axis of the thru-passage 128 (from the direction of flow), however other orientations are possible. The opposite surface 146 may be provided at any angle relative to the axis of the thru-passage 128.

The fluid from the hose 18 flows through the fitting 110 and is incident on the incident surface 144. If the hose 18 is properly assembled over the fitting 110, and specifically, over the top of the opening 142 to seal the opening, then the fluid will continue to flow through the fitting to the engine 14. If the hose 18 is not properly assembled over the top of the fitting 110, and specifically over the top of the opening 142, at least a portion of the fluid flow will flow out of the opening, flow incident to the incident surface 144, and will make an audible “whistle” sound.

It is possible that the misassembly indicator 40, 140 has a shape, such as round or oval, which would provide the audible “whistle” sound irrespective of the direction of fluid flow. In such a configuration, the same fitting 10, 110 could be used for either direction of fluid flow, or for applications where the direction of fluid flow is reversed.

The fitting 10, 110 is assembled to the engine 14, and the hose 18 is attached to the fitting 10, 110. To detect whether the hose-to-fitting assembly is misassembled, the engine 14 is run. If an audible “whistle” sound is detected when the engine is run, it is an indicator that the hose 18 may be misassembled to the engine 14.

What is claimed is:

1) A method of testing the fluid connection of a hose with an engine, the method comprising:
providing an engine having a fitting fluidly connected, the fitting having a body defining a thru-passage, the body having a first end portion received by the engine, a second end portion opposite the first end portion and defining an outlet of the thru-passage, and a misassembly indicator disposed between the first end portion and the second end portion, wherein the misassembly indicator comprises an opening in the body in fluid communication with the thru-passage which generates an audible sound when fluid passes through the opening in the body;
connecting a hose to the fitting;
running the engine; and
detecting whether an audible sound is generated from the fitting.

2) The method of claim 1 in which the fitting and hose are configured to prevent the generation of the audible sound when the hose is properly connected to the fitting.

3) The method of claim 1 further comprising locating the opening in the body such that the hose covers the opening to prevent the generation of the audible sound when the hose is connected to the fitting properly during the running of the engine, and such that the hose does not cover the opening when the hose is connected to the fitting improperly whereby the audible sound is produced during the running of the engine.

4) A fitting for communicating fluid from a source to a recipient, the fitting comprising:
a body defining a thru-passage, the body having a first end portion received by one of the source and the recipient, and a second end portion opposite the first end portion;
an outlet of the thru-passage defined by the second end portion; and
a misassembly indicator disposed between the first end portion and the second end portion, wherein the misassembly indicator has an opening in the body in fluid communication with the thru-passage.

5) The fitting of claim 4 wherein the opening of the misassembly indicator is defined by an incident surface.

6) The fitting of claim 5 wherein the thru-passage generally defines an axis, and the incident surface is generally provided at an obtuse angle with respect to the axis as taken from the direction of fluid flow.

7) The fitting of claim 5 wherein the opening of the misassembly indicator is defined by an opposite surface located opposite from the incident surface.

8) The fitting of claim 4 wherein the body is formed of metal.

9) The fitting of claim 4 wherein the body is formed of plastic.

10) The fitting of claim 4 wherein the body is generally tubular shaped.

11) The fitting of claim 4 further comprising a stop disposed on the body.

12) The fitting of claim 11 wherein the stop is an annular lip.

13) The fitting of claim 11 further comprising a barb disposed on the body, wherein the barb and the stop define a clamping portion therebetween, the clamping portion configured to receive a clamp.

14) The fitting of claim 13 wherein the barb is an annular lip.

15) The fitting of claim 4 wherein the misassembly indicator is generally triangular-shaped.

16) A fitting for communicating fluid between an engine and a hose, the fitting comprising:
a body defining a thru-passage for fluid communication between the engine and the hose, the body having a first end portion received by one of the engine and the hose, and a second end portion opposite the first end portion;
an outlet of the thru-passage defined by the second end portion; and
a misassembly indicator disposed between the first end portion and the second end portion, wherein the misassembly indicator comprises an opening in the body in fluid communication with the thru-passage configured to create an audible sound when fluid flow through the opening.

17) The fitting of claim 16 wherein the body further comprises a stop located at the first end portion, wherein the stop is a generally annular lip and the hose sufficiently blocks fluid flow through the opening in the body when the hose is connected to the body extending up to the stop to prevent the generation of the audible sound, but does not block fluid flow through the opening in the body when the hose is not connected to the body up to the stop such that the audible sound is generated during the running of the engine.
